(19) United States
(12) Patent Application Publication
(10) Pub. No.: US 2014/0081728 A1
(43) Pub. Date: Mar. 20, 2014

(54) ONLINE POINT REDEMPTION AND DISTRIBUTION SYSTEM

(71) Applicant: ZHENG-XIAN QIU, Taoyuan County (TW)

(72) Inventor: ZHENG-XIAN QIU, Taoyuan County (TW)

(21) Appl. No.: 14/088,734

(22) Filed: Nov. 25, 2013

Related U.S. Application Data
(62) Division of application No. 13/437,925, filed on Apr. 2, 2012.

(30) Foreign Application Priority Data
Feb. 13, 2012 (TW) 101104480

(51) Int. Cl. G06Q 30/02

(52) U.S. Cl. CPC G06Q 30/0233; G06Q 30/0215
USPC 705/14.17

(57) ABSTRACT

An online point redemption and distribution system. The online point redemption and distribution system is used in combination with a cloud computing operating system to allow consumers and stores to do transaction online, every transaction between the consumers and the stores will be recorded as points, and then the points can be redeemed into virtual money and deposited in consumer's account. Therefore, it will enhance consumers' loyalty. The online point redemption and distribution system includes a website operation platform and an application programming interface module.

This application is a divisional application of U.S. patent application Ser. No. 13/437,925, which claims the benefit of the earlier filing date of Apr. 2, 2012. Claims 1-3 of this application are the same as the previous claims 1-3 of the U.S. patent application Ser. No. 13/437,925.

### BACKGROUND OF THE INVENTION

1. Field of the Invention

The present invention relates to network communication field, and more particularly to an online point redemption and distribution system.

2. Description of the Prior Art

Today, blog has become one of the most popular methods of interactive communications among modern people. Therefore, most of the physical retail outlets have their own blogs or websites to advertise products and attract consumer's attention.

Virtual stores mostly pay to become members of an online shopping website which provides functionality on buying and selling goods, so that virtual store owners don't have to set up their own website. Virtual stores can also promote sales by paying to increase exposure rate.

However, the abovementioned advertising strategies are also used by competitors to distract consumers. Therefore, it will enhance consumers' loyalty if they can get reward after each online purchase.

The present invention has arisen to mitigate and/or obviate the afore-described disadvantages.

### SUMMARY OF THE INVENTION

The primary object of the present invention is to provide an online point redemption and distribution system. The online point redemption and distribution system is connected to a cloud computing operating system to allow consumers and stores to do transaction online, every transaction between the consumers and the stores will be recorded as points, and then the points can be redeemed into virtual money and deposited in consumer's account. Therefore, it will enhance consumers' loyalty.

To achieve the above object, an online point redemption and distribution system used in combination with a cloud computing operating system to calculate and save points produced by online transaction, comprises a website operation platform and an application programming interface module.

The website operation platform is connected to the cloud computing operating system to allow consumers and stores to do transaction online, a transaction history record is formed and stored in the cloud computing operating system after transaction. The application programming interface module is stored in cloud computing operating system to allow the stores or consumers to access the cloud computing operating system via the website operation platform. The application programming interface module includes a point distribution interface is provided with a distribution data, so that based on the distribution data and the transaction history record, the cloud computing operating system calculates and distributes the points produced by online transaction. A point redemption interface is provided with a redemption data, so that points earned by the consumers from different stores are added up and converted into virtual money. A point read interface is used to read balance of points and virtual money in a consumer account. A website background management system is used for managing the cloud computing operating system and the cloud computing operating system and the website operation platform.

### BRIEF DESCRIPTION OF THE DRAWINGS

FIG. 1 is a diagram showing an online point redemption and distribution system in accordance with a preferred embodiment of the present invention;

FIG. 2 is a diagram showing an application programming interface module in accordance with the present invention;

FIG. 3 is a flow chart showing an online point distribution method in accordance with the present invention; and

FIG. 4 is a flow chart showing an online point redemption method in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

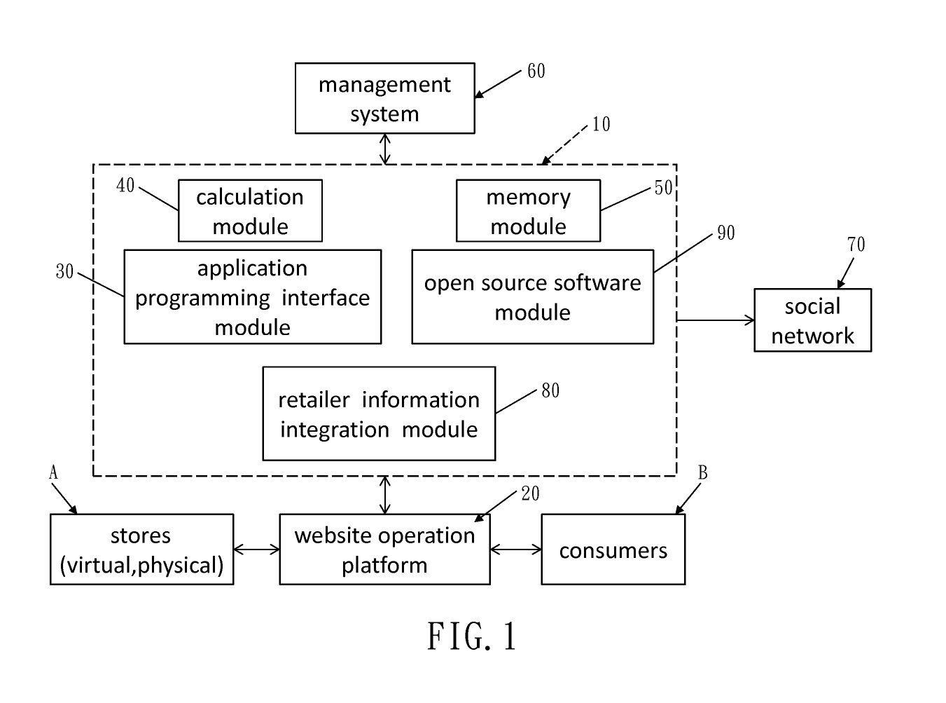

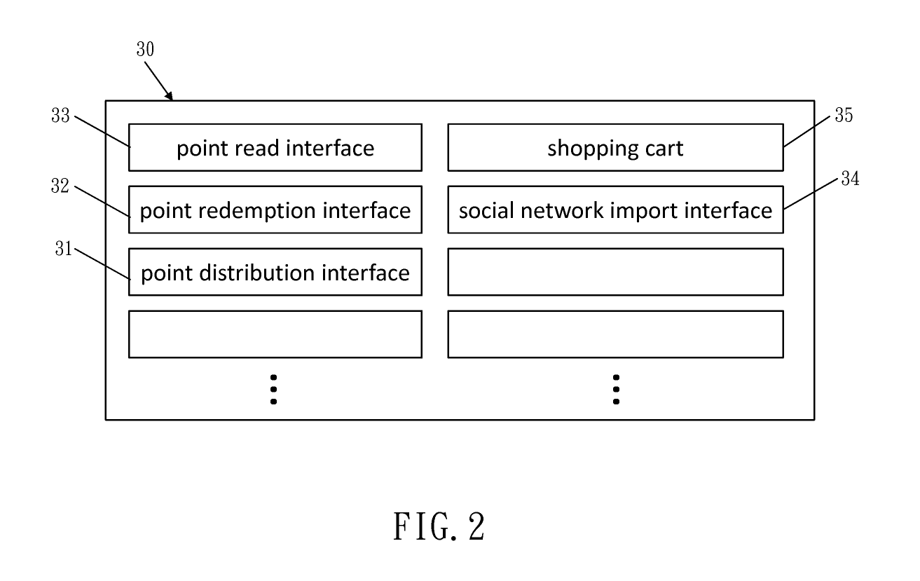

Referring to FIGS. 1 and 2, an online point redemption and distribution system in accordance with a preferred embodiment of the present invention is used in combination with a cloud computing operating system 10 to calculate and save the points produced by online transaction. The online point redemption and distribution system comprises a website operation platform 20 connected to a website background management system 60 via the cloud computing operating system 10, an application programming interface module 30 stored in the cloud computing operating system 10, a calculation module 40, a memory module 50, and a retailer information integration module 80.

An user interface of the website operation platform 20 connected to cloud computing operating system 10 allows consumers B and stores A to get into cloud computing operating system 10 to look through commodity information, buying and selling commodities, or changing data. Every transaction between the consumers B and the stores A will be recorded in transaction history in the memory module 50 of cloud computing operating system 10.

The website background management system 60 is connected to cloud computing operating system 10 to manage cloud computing operating system 10 and website operation platform 20.

The retailer information integration module 80 is provided for integrating physical stores and virtual stores and providing the respective stores A with their own exclusive cyber space to display commodity information, so that the consumers B can look through the information and do transaction through website operation platform 20. When the blogs of the virtual stores are integrated with the online point redemption and distribution system of the present invention, the virtual stores can obtain application programming interface module 30 via cloud computing operating system 10 and use application programming interface module 30 to perfect the blog, thus facilitating online transaction. Furthermore, when an independent website of the stores A is integrated with the online point redemption and distribution system of the present invention, the stores A can use an open source software module 90 stored in cloud computing operating system 10 to quick expand the function of the website.

In this embodiment, application programming interface module 30 is essentially provided for allowing the stores A to have access to cloud computing operating system 10 via website operation platform 20 to select the application programming interface module 30, and put the application programming interface module 30 into the exclusive cyber space of the retailer information integration module 80. Application programming interface module 30 comprises a point distribution interface 31 (hereafter called as API 31), a point redemption interface 32 (hereafter called as API 32), and a point read interface 33 (hereafter called as API 33).

The API 31 allows the stores A to preset a distribution data, based on the distribution data and the transaction history record, cloud computing operating system 10 calculates and distributes the points produced by transactions. The API 32 allows the consumers B to preset a redemption data, so that the points earned by the consumers from different stores can be added up and converted into virtual money. The API 33 allows the consumers B to read the balance of points and virtual money of the consumers' account.

Application programming interface module 30 further comprises a social network import interface 34 (hereafter called as API 34) and a shopping cart 35 (hereafter called as API 35). The API 34 allows the stores A to import a social network 70 into their exclusive cyber space in the online point redemption and distribution system of the present invention, so that the subscribers to the social network 70 can be linked to the online point redemption and distribution system. The API 35 allows the stores A whose blogs are integrated with the retailer information integration module 80 to insert the API 35 into their blogs, making online transaction easier.

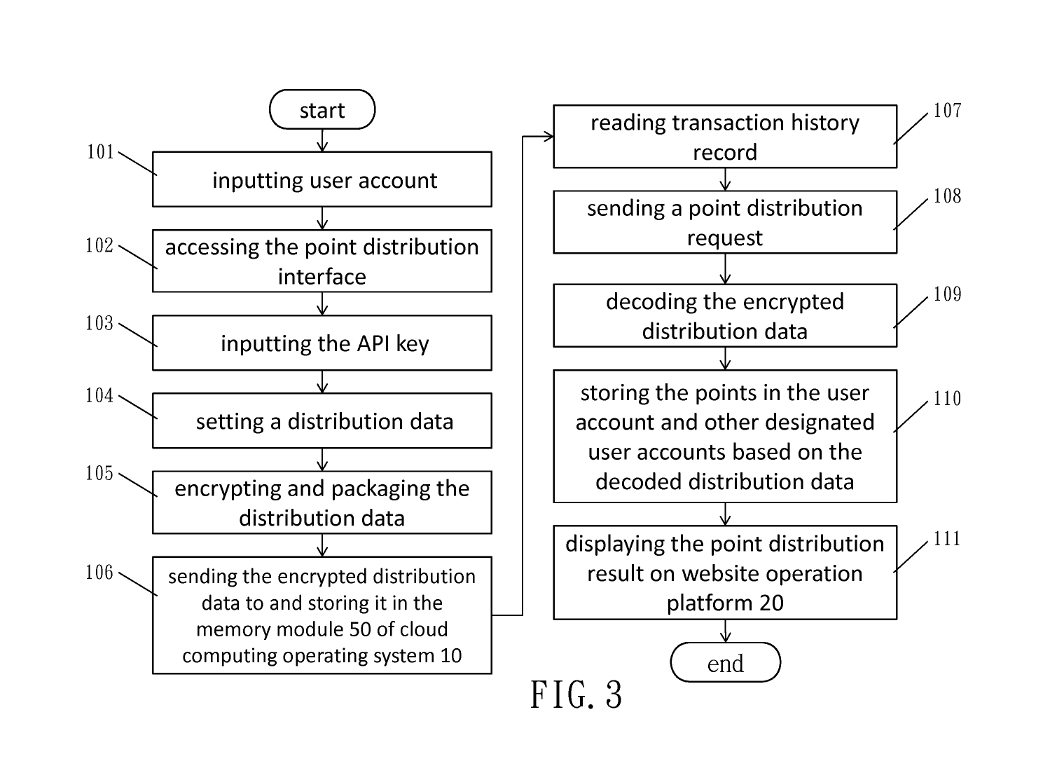

Referring to FIG. 3, an online point distribution method in accordance with the present invention comprises the following steps: step 101: the stores A access website operation platform 20 by inputting user account; step 102: accessing an operating interface via the API 31; step 103: obtaining an API key corresponding to the user account, then inputting the API key into the operating interface of the API 31; step 104: setting a distribution data which includes the user account of the stores A and the consumers B and corresponding points by using the operating interface of the API 31; step 105: encrypting and packaging the distribution data; step 106: sending the encrypted distribution data to and storing it in the memory module 50 of cloud computing operating system 10.

When website operation platform 20 outputs a transaction history record to the memory module 50, the memory module 50 will read (step 107) and send a point distribution request to the calculation module 40 of cloud computing operating system 10 (step 108). The calculation module 40 decodes the encrypted distribution data stored in the memory module 50 (step 109), and then the calculation module 40 stores the points in the user account and other designated user accounts based on the decoded distribution data (step 110), and finally the point distribution result is displayed on website operation platform 20 (step 111).

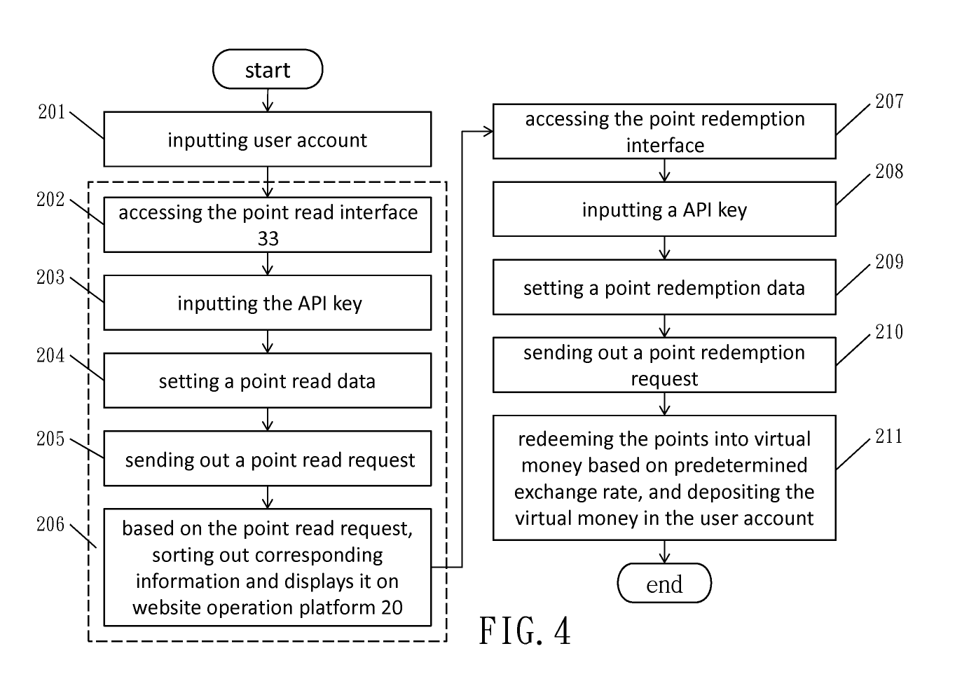

Referring to FIG. 4, an online point redemption method in accordance with the present invention comprises the following steps: the consumers B access website operation platform 20 by inputting user account (step 201), then chooses to or not to read the types and source of points and balance of points in their user account by following the following steps of 202 to 206.

Firstly, accessing the operating interface of the API 33 (step 202); obtaining an API key corresponding to the user account, then inputting the API key into the operating interface of the API 33 (step 203); setting a point read data by using the operating interface of the API 33 (step 204); sending a point read request from the operating interface of the API 33 to the memory module 50 of cloud computing operating system 10 (step 205); then based on the point read request, the memory module 50 sorts out corresponding information and displays it on website operation platform 20 (step 206) for the consumers' reference.

After confirming the balance of points, the consumers B can access the operating interface of the API 32 (step 207), obtaining a API key and inputting it in the operating interface of the API 33 by repeating the aforementioned steps (step 208); setting a point redemption data which includes the types and amount of the points to be redeemed (step 209) by using the API 32; sending a point redemption request to the memory module 50 of cloud computing operating system 10 (step 210); finally, the memory module 50 redeems the points into virtual money based on predetermined exchange rate, and deposits the virtual money in the user account (step 211).

While we have shown and described various embodiments in accordance with the present invention, it is clear to those skilled in the art that further embodiments may be made without departing from the scope of the present invention.

What is claimed is:

1. An online point redemption and distribution system used in combination with a cloud computing operating system to calculate and save points produced by online transaction, comprising:
a website operation platform connected to the cloud computing operating system to allow consumers and stores to do transaction online, a transaction history record being formed and stored in the cloud computing operating system after transaction;
an application programming interface module stored in cloud computing operating system to allow the stores or consumers to access the cloud computing operating system via the website operation platform, the application programming interface module including:
a point distribution interface provided with a distribution data, so that based on the distribution data and the transaction history record, the cloud computing operating system calculates and distributes the points produced by online transaction;
a point redemption interface provided with a redemption data, so that points earned by the consumers from different stores are added up and converted into virtual money;
a point read interface used to read balance of points and virtual money in a consumer account; and
a website background management system for managing the cloud computing operating system and the website operation platform.

2. The online point redemption and distribution system as claimed in claim 1, wherein the cloud computing operating system comprises a computing module and a memory module, the computing module cooperates with the point distribution interface to calculate the points produced by online transaction completed on the website operation platform, and to store the points in the memory module.

3. The online point redemption and distribution system as claimed in claim 1, wherein the application programming interface module further comprises a social network import interface which allows subscribers of a social network to be linked to the online point redemption and distribution system.
